(19) United States
(12) Patent Application Publication
(10) Pub. No.: US 2025/0210954 A1
(43) Pub. Date: Jun. 26, 2025

(54) CONDUCTOR

(71) Applicant: Yazaki Corporation, Tokyo (JP)

(72) Inventors: Tomohiro Urashima, Tochigi (JP); Hiroyasu Furuya, Tochigi (JP); Genki Furuya, Tochigi (JP); Kohki Nakamura, Tochigi (JP)

(21) Appl. No.: 18/987,318

(22) Filed: Dec. 19, 2024

(30) Foreign Application Priority Data
Dec. 20, 2023 (JP) 2023-214781

(51) Int. Cl. H02G 5/06

(52) U.S. Cl. CPC H02G 5/068

(57) ABSTRACT

A conductor includes a pair of bus bars, and an exterior component attached to the pair of bus bars. Each of the pair of bus bars includes a conductor portion and an insulating sheath with which the conductor portion is covered, and at least partially includes an attached portion extending in a linear shape. The exterior component includes a pair of groove portions extending in a linear shape so as to be capable of accommodating the attached portions of the pair of bus bars, and a pair of cover portions capable of opening and closing opening portions of the pair of groove portions. The pair of cover portions are arranged such that one and the other of the pair of cover portions overlap each other when the opening portions of both of the pair of groove portions are closed.

### CROSS-REFERENCE TO RELATED APPLICATIONS

This application is based on and claims priority under 35 USC 119 from Japanese Patent Application No.2023-214781 filed on Dec. 20, 2023, the entire content of which is incorporated herein by reference.

### TECHNICAL FIELD

The present disclosure relates to a conductor including a pair of bus bars and an exterior component attached to the pair of bus bars.

### BACKGROUND ART

In the related art, when routing a metal bus bar in an automobile or the like, it has been proposed to assemble an insulating exterior component so as to cover the bus bar and, if necessary, to fix the exterior component to a vehicle body or the like of the automobile or the like as disclosed, for example, in JP2018-190532A.

The above type of bus bar generally has a shape extending along a predetermined routing path (so-called a layout) according to the specifications of the automobile or the like. Similarly, the exterior component generally has a shape corresponding to the routing path so that such a bus bar can be accommodated. In other words, the exterior component has a dedicated shape that differs for each specification of the bus bar. Therefore, as a matter of course, if the shape of the bus bar is different, the shape of the exterior component is also different. On the contrary, if the exterior component is generalized, a degree of design freedom in the shape of the bus bar decreases. For this reason, it is generally difficult to achieve both improvement of the degree of design freedom in the shape of the bus bar and improvement of versatility of the exterior component.

An object of the present disclosure is to provide a conductor capable of achieving both improvement of a degree of design freedom in shapes of bus bars and improvement of versatility of an exterior component.

### SUMMARY OF INVENTION

In order to achieve the above object, the conductor according to the present disclosure is characterized as follows.

A conductor includes a pair of bus bars, and an exterior component attached to the pair of bus bars. Each of the pair of bus bars includes a conductor portion and an insulating sheath with which the conductor portion is covered, and at least partially includes an attached portion extending in a linear shape. The exterior component includes a pair of groove portions extending in a linear shape so as to be capable of accommodating the attached portions of the pair of bus bars, and a pair of cover portions capable of opening and closing opening portions of the pair of groove portions. The pair of cover portions are arranged such that one and the other of the pair of cover portions overlap each other when the opening portions of both of the pair of groove portions are closed.

According to the conductor of the present disclosure, each of the pair of bus bars includes the conductor portion covered with the insulating sheath, and at least partially includes the attached portion extending in a linear shape. The attached portion is used to attach the bus bar and the exterior component. Specifically, the attached portions of the pair of bus bars are accommodated in the pair of groove portions of the exterior component, respectively. In this way, the conductor portion of the bus bar is covered with the insulating sheath, and thus it is not necessary to provide the exterior component so as to cover the entire bus bars. Further, the exterior component only needs to have the groove portions capable of accommodating the attached portions in a linear shape and the cover portions for opening and closing the groove portions, and does not need to have a dedicated shape for each bus bar. Accordingly, versatility of the exterior component can be improved. On the other hand, in the bus bar, a shape of a location other than the attached portion can be designed without considering the presence of the exterior component. Accordingly, a degree of design freedom in the shapes of the bus bars can be improved. Therefore, the conductor having the present configuration can achieve both the improvement of the degree of design freedom in the shapes of the bus bars and the improvement of the versatility of the exterior component.

Furthermore, the conductor of the present disclosure also has other effects. Specifically, the pair of cover portions are arranged such that one and the other of the pair of cover portions overlap each other when the opening portions of both of the pair of groove portions are closed. Accordingly, when the pair of cover portions are opened, the upper cover portion is opened first, and then the lower cover portion is opened. That is, an order of opening the pair of cover portions is regulated. Accordingly, when the bus bars are detached from the exterior component, one of the bus bars is prevented from coming into contact with the other of the bus bars, thereby preventing an unintended short circuit between the bus bars. In addition, it is possible to reduce a size of the exterior component or to improve a workability of a work of attaching the exterior component to the bus bars.

The present disclosure is briefly described above. Further, details of the present disclosure will be clarified by reading modes for carrying out the disclosure described below with reference to the accompanying drawings.

### BRIEF DESCRIPTION OF DRAWINGS

FIG. 1 is a perspective view showing an assembled state of a conductor according to an embodiment of the present disclosure;

FIG. 2 is a perspective view showing a state in which a second bus bar is separated from an exterior component in the conductor shown in FIG. 1;

FIG. 3 is a perspective view showing a state in which both a first bus bar and the second bus bar are separated from the exterior component in the conductor shown in FIG. 1;

FIG. 4 is a cross-sectional view taken along a line A-A in FIG. 1;

FIG. 5 is a cross-sectional view taken along a line B-B in FIG. 2; and

FIG. 6 is a cross-sectional view taken along a line C-C in FIG. 3.

### DESCRIPTION OF EMBODIMENTS

### Embodiment

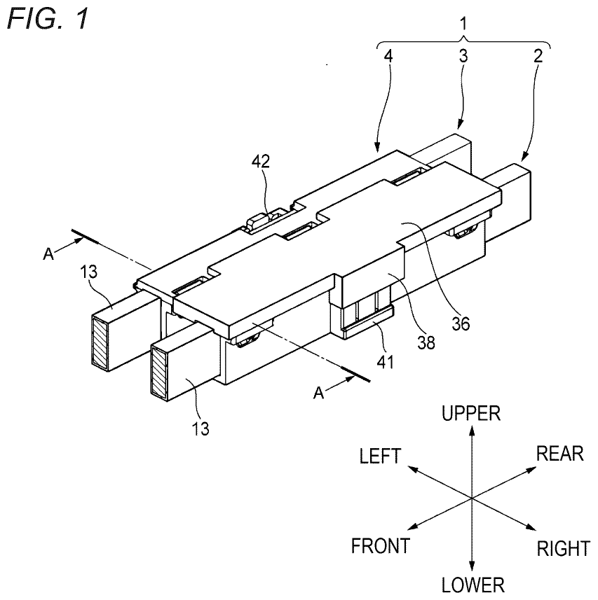

Hereinafter, a conductor 1 according to an embodiment of the present disclosure will be described with reference to the drawings. As shown in FIGS. 1 to 3, the conductor 1 includes a first bus bar 2, a second bus bar 3, and an exterior component 4 attached to attached portions 13, each of which is a part of each of the first bus bar 2 and the second bus bar 3 in an extending direction. In FIGS. 1 to 3, only the attached portions 13 of the first bus bar 2 and the second bus bar 3 are shown. Typically, the conductor 1 is used by being mounted on an automobile or the like in a state in which the first bus bar 2 and the second bus bar 3 are routed in the automobile or the like, and the exterior component 4 attached to the attached portions 13 of the first bus bar 2 and the second bus bar 3 is fixed to a vehicle body or the like of the automobile or the like.

Hereinafter, for convenience of description, “front”, “rear”, “left”, “right”, “upper”, and “lower” are defined as shown in FIG. 1 or the like. A “front-rear direction”, a “left-right direction”, and an “upper-lower direction” are orthogonal to one another. The front-rear direction coincides with the extending direction of the attached portions 13 of the first bus bar 2 and the second bus bar 3 and an extending direction of the exterior component 4. These directions are merely defined for the convenience of description, and do not necessarily correspond to, for example, the front-rear direction, the left-right direction, and the upper-lower direction of the automobile or the like when the conductor 1 is mounted on the automobile or the like. Hereinafter, a configuration of each component constituting the conductor 1 will be described in order.

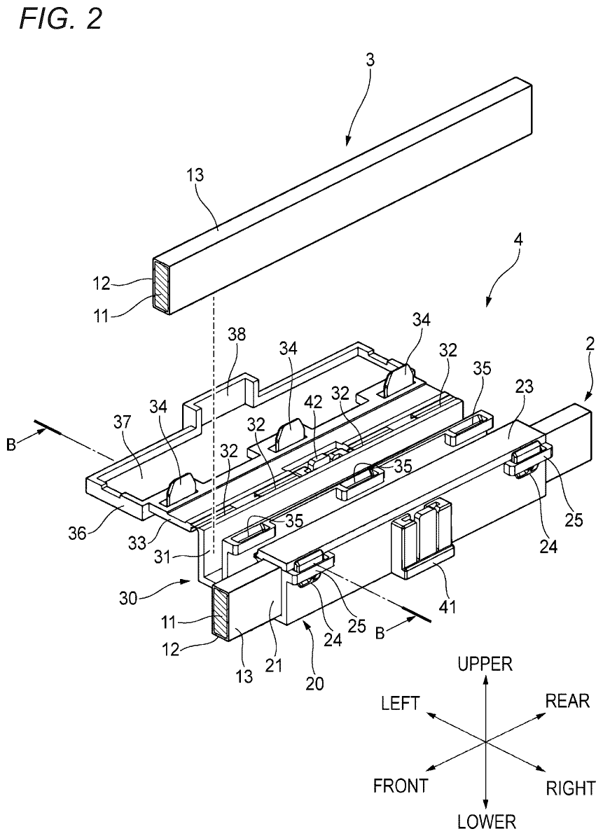

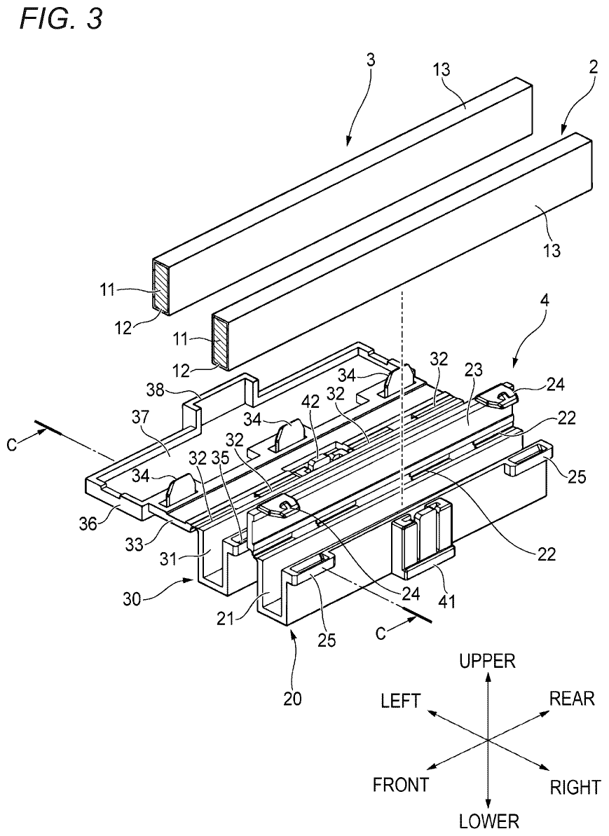

First, the first bus bar 2 and the second bus bar 3 will be described. The first bus bar 2 and the second bus bar 3 each have a shape (for example, a shape extending while being bent three-dimensionally) extending along a routing path according to the specifications of the automobile or the like, and includes a conductor portion 11 that extends in the above shape and an insulating sheath 12 with which an outer periphery of the conductor portion 11 is covered (see FIGS. 2 and 3). In this example, a portion (conductor portion 11) shown in FIGS. 1 to 6, which is a part of each of the first bus bar 2 and the second bus bar 3, is a metal plate having a rectangular cross section and extending in an elongated shape, and the insulating sheath 12 covers the outer periphery of the conductor portion 11 over an entire region of the conductor portion 11 in the extending direction. A shape of a portion (not shown) of each of the first bus bar 2 and the second bus bar 3 may be determined based on the specifications or the like of the first bus bar 2 and the second bus bar 3, and may not necessarily have a linear shape.

As shown in FIGS. 1 to 3, each of the first bus bar 2 and the second bus bar 3 has, as the attached portion 13, a portion extending in a linear shape in the front-rear direction in a part in the extending direction (that is, conductor portion 11 covered with the insulating sheath 12 and extending in a linear shape). In this example, the entire region of the conductor portion 11 itself in the extending direction is covered with the insulating sheath 12, and thus it is not necessary to provide the exterior component 4 so as to cover the entire region of the first bus bar 2 and the second bus bar 3 in the extending direction. Therefore, in this example, the exterior component 4 is attached to the first bus bar 2 and the second bus bar 3 so as to cover (accommodate) only (a part or the whole in the extending direction of) the attached portions 13, which are a part of the first bus bar 2 and the second bus bar 3 in the extending direction. Accordingly, the exterior component 4 only needs to be capable of accommodating only (a part or the whole in the extending direction of) the attached portions 13 in a linear shape of the first bus bar 2 and the second bus bar 3, and does not need to have a dedicated shape for each bus bar, and thus has high versatility. On the other hand, in the first bus bar 2 and the second bus bar 3, a shape of a location other than the attached portions 13 can be designed without considering the presence of the exterior component 4. Accordingly, a degree of design freedom in the shapes of the first bus bar 2 and the second bus bar 3 is high.

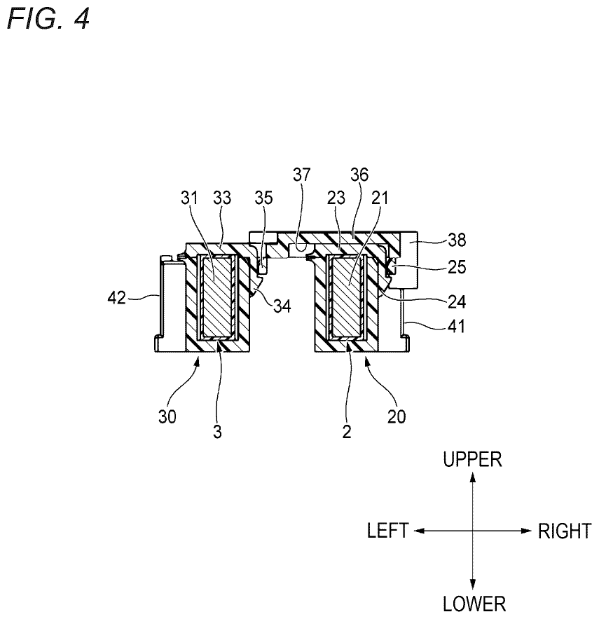

Next, the exterior component 4 will be described. The exterior component 4 is a resin molded body, and includes a first block 20 extending in the front-rear direction and a second block 30 extending in the front-rear direction as shown in FIGS. 2 to 6. The first block 20 and the second block 30 are separate from each other, and the first block 20 and the second block 30 are coupled to each other by an extended cover portion 36 to be described later in a state in which the first block 20 and the second block 30 adjacent to a left side of the first block 20 are arranged in the left-right direction (see FIGS. 1 and 4). In this example, a length of the second block 30 in the front-rear direction is substantially equal to a length of the first block 20 in the front-rear direction, and in the coupled state of the first block 20 and the second block 30, the entire region of the first block 20 in the front-rear direction and the entire region of the second block 30 in the front-rear direction are arranged side by side in the left-right direction (see FIG. 1).

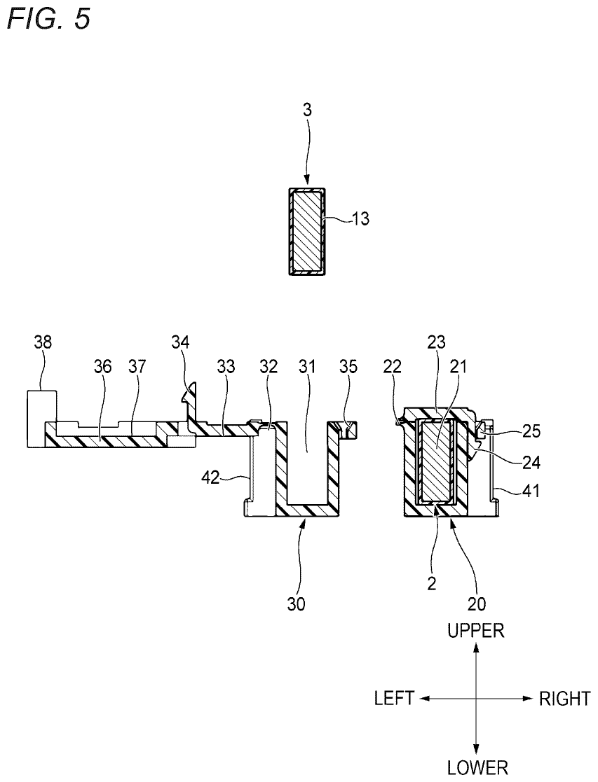

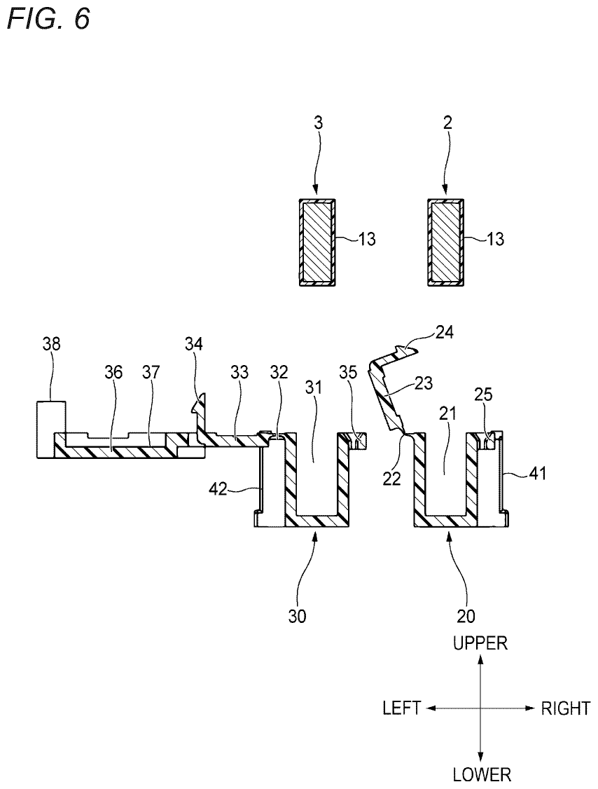

The first block 20 has a substantially U-shape opening upward as viewed in the front-rear direction, extends in a linear shape in the front-rear direction, and defines a first groove portion 21 opening upward and extending in a linear shape in the front-rear direction (see FIGS. 2 and 6 and the like). The first groove portion 21 accommodates the attached portion 13 of the first bus bar 2. A first cover portion 23 is coupled to an upper end portion of a left side wall of the first block 20 via a plurality of (four) hinge portions 22 arranged in the front-rear direction so as to be capable of opening and closing an opening portion of the first groove portion 21. The first cover portion 23 has a substantially rectangular flat plate shape extending in the front-rear direction corresponding to a shape of the opening portion of the first groove portion 21. A pair of front and rear engaging portions 24 are provided at both end portions in the front-rear direction of end edge portions of the first cover portion 23, which extend in the front-rear direction on sides opposite to the plurality of hinge portions 22. In a state in which the first cover portion 23 is closed (that is, in a state in which the opening portion of the first groove portion 21 is closed), the pair of front and rear engaging portions 24 are engaged with a pair of front and rear engaged portions 25 provided at upper end portions of a right side wall of the first block 20 (see FIGS. 2 and 5). In this example, the engaging portion 24 is a locking piece having a locking protrusion, and the engaged portion 25 is a locking hole into which an engaging piece is inserted to lock the locking protrusion. A fixing portion 41 to be fixed to the vehicle body or the like of the automobile or the like is provided at a center portion in the front-rear direction of an outer face of the right side wall of the first block 20.

The second block 30 has a substantially U-shape opening upward as viewed in the front-rear direction, extends in a linear shape in the front-rear direction, and defines a second groove portion 31 opening upward and extending in a linear shape in the front-rear direction (see FIGS. 2 and 6 and the like). The second groove portion 31 accommodates the attached portion 13 of the second bus bar 3. A second cover portion 33 is coupled to an upper end portion of a left side wall of the second block 30 via a plurality of (four) hinge portions 32 arranged in the front-rear direction so as to be capable of opening and closing an opening portion of the second groove portion 31. The second cover portion 33 has a substantially rectangular flat plate shape extending in the front-rear direction corresponding to a shape of the opening portion of the second groove portion 31. A plurality of (three) engaging portions 34 arranged in the front-rear direction are provided at end edge portions of the second cover portion 33, which extend in the front-rear direction on sides opposite to the plurality of hinge portions 32. In a state in which the second cover portion 33 is closed (that is, in a state in which the opening portion of the second groove portion 31 is closed), the plurality of engaging portions 34 are engaged with a plurality of (three) engaged portions 35 arranged in the front-rear direction and provided at upper end portions of a right side wall of the second block 30 (see FIG. 4). In this example, the engaging portion 34 is a locking piece having a locking protrusion, and the engaged portion 35 is a locking hole into which an engaging piece is inserted to lock the locking protrusion. A fixing portion 42 to be fixed to the vehicle body or the like of the automobile or the like is provided at a center portion in the front-rear direction of an outer face of the left side wall of the second block 30.

The second cover portion 33 is further integrally provided with the extended cover portion 36. The extended cover portion 36 is a substantially rectangular flat plate-shaped portion that further extends in a planar direction of the second cover portion 33 toward sides opposite to the plurality of hinge portions 32 from the “end edge portions provided with the plurality of engaging portions 34 and extending in the front-rear direction” of the second cover portion 33. In the state in which the second cover portion 33 is closed (that is, in the state in which the opening portion of the second groove portion 31 is closed), the extended cover portion 36 is a portion that overlaps an upper side of the first cover portion 23 that closes the opening portion of the first groove portion 21 of the first block 20, and functions to couple the first block 20 and the second block 30 (see FIGS. 1 and 4). A recess 37 for accommodating the first cover portion 23 is formed on a face of the extended cover portion 36 that overlaps the first cover portion 23 (when the second cover portion 33 is in the closed state) (see FIG. 2 and the like). A center portion in the front-rear direction of an extended end edge portion extending in the front-rear direction of the extended cover portion 36 is provided with a covering portion 38 with which an upper end portion of the fixing portion 41 is covered in the closed state of the second cover portion 33 (in the state in which the extended cover portion 36 overlaps the upper side of the first cover portion 23). Here, the second cover portion 33 and the extended cover portion 36 correspond to “the other of the pair of cover portions” of the present disclosure. The configuration of each component constituting the conductor 1 has been described above.

Next, a procedure for attaching the exterior component 4 to the first bus bar 2 and the second bus bar 3 will be described. In order to attach the exterior component 4 to the first bus bar 2 and the second bus bar 3, first, as shown in FIGS. 3 and 6, with respect to the exterior component 4 in which the first block 20 and the second block 30, which is separate from the first block 20 and is adjacent to the left side of the first block 20, are arranged in the left-right direction, and the first cover portion 23 and the second cover portion 33 are in an open state, the attached portion 13 which is a part of the first bus bar 2 in the extending direction is disposed above the first groove portion 21 that opens upward, and the attached portion 13 which is a part of the second bus bar 3 in the extending direction is disposed above the second groove portion 31 that opens upward. Next, the attached portion 13 of the first bus bar 2 is moved downward and accommodated in the first groove portion 21, and the first cover portion 23 is closed (see FIGS. 2 and 5). Next, the attached portion 13 of the second bus bar 3 is moved downward and accommodated in the second groove portion 31, and the second cover portion 33 is closed. When the second cover portion 33 is closed, the extended cover portion 36 integrated with the second cover portion 33 overlaps the upper side of the first cover portion 23 which closes the opening portion of the first groove portion 21 of the first block 20, and the first cover portion 23 is accommodated in the recess 37, and when the covering portion 38 covers the upper end portion of the fixing portion 41 of the first block 20, the first block 20 and the second block 30 are coupled to each other (see FIGS. 1 and 4). Accordingly, the attachment of the exterior component 4 to the first bus bar 2 and the second bus bar 3 is completed, and the conductor 1 in the assembled state shown in FIG. 1 is obtained. In the assembled state of the conductor 1, the first cover portion 23 is maintained in the closed state by the engagement of the engaging portions 24 and the engaged portions 25, and the second cover portion 33 is maintained in the closed state by the engagement of the engaging portions 34 and the engaged portions 35. Further, the covering portion 38 is maintained in a state of covering the upper end portion of the fixing portion 41 of the first block 20, whereby the state in which the first block 20 and the second block 30 are coupled to each other is maintained.

In this example, when the opening portions of both the first groove portion 21 and the second groove portion 31 are closed, the extended cover portion 36 integrated with the second cover portion 33 is disposed so as to overlap the upper side of the first cover portion 23. Accordingly, when the first cover portion 23 and the second cover portion 33 are closed, the second cover portion 33 is closed after the first cover portion 23 is closed. That is, an order of closing the first cover portion 23 and the second cover portion 33 is regulated.

The conductor 1 that has been assembled is mounted on the automobile or the like in a state in which the first bus bar 2 and the second bus bar 3 are routed in the automobile or the like and the pair of fixing portions 41, 42 (see FIG. 1 or the like) provided in the exterior component 4 attached to the attached portions 13 of the first bus bar 2 and the second bus bar 3 are fixed to the vehicle body or the like of the automobile or the like.

When the first bus bar 2 and the second bus bar 3 are detached from the exterior component 4 in the conductor 1 that has been assembled, first, the closed second cover portion 33 is opened, and the attached portion 13 of the second bus bar 3 is moved upward toward the outside of the second groove portion 31 via the opening portion that opens upward of the second groove portion 31 (see FIGS. 2 and 5). When the second cover portion 33 is opened, the state in which the extended cover portion 36 overlaps the upper side of the first cover portion 23 is released, so that the first cover portion 23 can be opened. Next, the closed first cover portion 23 is opened, and the attached portion 13 of the first bus bar 2 is moved upward toward the outside of the first groove portion 21 via the opening portion that opens upward of the first groove portion 21 (see FIGS. 3 and 6). Accordingly, the work of detaching the first bus bar 2 and the second bus bar 3 from the exterior component 4 is completed.

In this example, when the opening portions of both the first groove portion 21 and the second groove portion 31 are closed, the extended cover portion 36 integrated with the second cover portion 33 is disposed so as to overlap the upper side of the first cover portion 23. Accordingly, when the first cover portion 23 and the second cover portion 33 are opened, the first cover portion 23 is opened after the second cover portion 33 is opened. That is, an order of opening the first cover portion 23 and the second cover portion 33 is regulated. Accordingly, when the first bus bar 2 and the second bus bar 3 are detached from the exterior component 4, one of the bus bars is prevented from coming into contact with the other of the bus bars, thereby preventing an unintended short circuit between the bus bars.

### Operations and Effects

According to the conductor 1 according to the present embodiment, the first bus bar 2 and the second bus bar 3 each include the conductor portion 11 covered with the insulating sheath 12, and at least partially includes the attached portion 13 extending in a linear shape. The attached portions 13 are used to attach the first bus bar 2 and the second bus bar 3 to the exterior component 4. Specifically, the attached portions 13 of the first bus bar 2 and the second bus bar 3 are accommodated in the first groove portion 21 and the second groove portion 31 of the exterior component 4, respectively. In this way, the conductor portion 11 of each of the first bus bar 2 and the second bus bar 3 is covered with the insulating sheath 12, and thus it is not necessary to provide the exterior component 4 so as to cover the entire first bus bar 2 and second bus bar 3. Further, the exterior component 4 only needs to have the first groove portion 21 and the second groove portion 31 capable of accommodating the attached portions 13 in a linear shape, and the first cover portion 23 and the second cover portion 33 for opening and closing the first groove portion 21 and the second groove portion 31, and does not need to have a dedicated shape for each bus bar. Accordingly, the versatility of the exterior component 4 can be improved. On the other hand, in the first bus bar 2 and the second bus bar 3, a shape of a location other than the attached portions 13 can be designed without considering the presence of the exterior component 4. Accordingly, the degree of design freedom in the shapes of the first bus bar 2 and the second bus bar 3 can be improved. Therefore, the conductor 1 can achieve both the improvement of the degree of design freedom in the shapes of the first bus bar 2 and the second bus bar 3 and the improvement of the versatility of the exterior component 4.

Further, the first cover portion 23 and the extended cover portion 36 integrated with the second cover portion 33 are disposed such that the extended cover portion 36 overlaps the upper side of the first cover portion 23 when the opening portions of both the first groove portion 21 and the second groove portion 31 are closed. Accordingly, when the first cover portion 23 and the second cover portion 33 are opened, the second cover portion 33 integrated with the upper extended cover portion 36 is opened, and then the lower first cover portion 23 is opened. That is, the order of opening the first cover portion 23 and the second cover portion 33 is regulated. Accordingly, when the first bus bar 2 and the second bus bar 3 are detached from the exterior component 4, one of the bus bars is prevented from coming into contact with the other of the bus bars, thereby preventing an unintended short circuit between the bus bars. In addition, it is possible to reduce a size of the exterior component 4 or to improve a workability of the work of attaching the exterior component 4 to the first bus bar 2 and the second bus bar 3.

Further, the first cover portion 23 is coupled to the first block 20 of the exterior component 4 so as to be displaceable in a hinge shape, and when the opening portion of the first groove portion 21 in the first block 20 is closed by the first cover portion 23, the engaging portions 24 of the first cover portion 23 are engaged with the engaged portions 25 provided in the first block 20. In contrast, the second cover portion 33 is coupled to the second block 30 of the exterior component 4 so as to be displaceable in a hinge shape. Further, when the opening portion of the second groove portion 31 in the second block 30 is closed by the second cover portion 33, the engaging portions 34 of the second cover portion 33 are engaged with the engaged portions 35 provided in the second block 30, and the extended cover portion 36 integrated with the second cover portion 33 overlaps the first cover portion 23 that closes the opening portion of the first groove portion 21 of the first block 20, and couples the first block 20 and the second block 30. Accordingly, even though the first block 20 and the second block 30 are separate bodies, the first block 20 and the second block 30 can be coupled to each other by the extended cover portion 36 integrated with the second cover portion 33 while the order of opening the first cover portion 23 and the second cover portion 33 is regulated.

### Other Embodiments

The present disclosure is not limited to the embodiment described above, and various modifications can be adopted within the scope of the present disclosure. For example, the present disclosure is not limited to the embodiment described above, and modifications, improvements, and the like can be appropriately made. In addition, the material, shape, size, number, arrangement position, and the like of components in the above embodiment are freely selected and are not limited as long as the present disclosure can be implemented.

In the above embodiment, the first block 20 and the second block 30 are separate bodies. In contrast, the first block 20 and the second block 30 may be an integral member coupled to each other.

Here, features of the embodiment of the conductor 1 according to the present disclosure described above are briefly summarized and listed in the following (i) to (ii).

(i)

A conductor (1) comprising:
a pair of bus bars (2, 3); and
an exterior component (4) attached to the pair of bus bars (2, 3), in which
each of the pair of bus bars (2, 3) includes a conductor portion (11) and an insulating sheath (12) with which the conductor portion (11) is covered, and at least partially includes an attached portion (13) extending in a linear shape,
the exterior component (4) includes a pair of groove portions (21, 31) extending in a linear shape so as to be capable of accommodating the attached portions (13) of the pair of bus bars (2, 3), and a pair of cover portions (23, 33, and 36) capable of opening and closing opening portions of the pair of groove portions (21, 31), and
the pair of cover portions (23, 33, and 36) are arranged such that one (23) and the other (36) of the pair of cover portions overlap each other when the opening portions of both of the pair of groove portions (21, 31) are closed.

According to the conductor having the configuration of the above (i), each of the pair of bus bars includes the conductor portion covered with the insulating sheath, and at least partially includes the attached portion extending in a linear shape. The attached portion is used to attach the bus bar and the exterior component. Specifically, the attached portions of the pair of bus bars are accommodated in the pair of groove portions of the exterior component, respectively. In this way, the conductor portion of the bus bar is covered with the insulating sheath, and thus it is not necessary to provide the exterior component so as to cover the entire bus bars. Further, the exterior component only needs to have the groove portions capable of accommodating the attached portions in a linear shape and the cover portions for opening and closing the groove portions, and does not need to have a dedicated shape for each bus bar. Accordingly, versatility of the exterior component can be improved. On the other hand, in the bus bar, a shape of a location other than the attached portion can be designed without considering the presence of the exterior component. Accordingly, a degree of design freedom in the shapes of the bus bars can be improved. Therefore, the conductor having the present configuration can achieve both the improvement of the degree of design freedom in the shapes of the bus bars and the improvement of the versatility of the exterior component.

Furthermore, the conductor having the above configuration also has other effects. Specifically, the pair of cover portions are arranged such that one and the other of the pair of cover portions overlap each other when the opening portions of both of the pair of groove portions are closed. Accordingly, when the pair of cover portions are opened, the upper cover portion is opened first, and then the lower cover portion is opened. That is, an order of opening the pair of cover portions is regulated. Accordingly, when the bus bars are detached from the exterior component, one of the bus bars is prevented from coming into contact with the other of the bus bars, thereby preventing an unintended short circuit between the bus bars. Further, it is possible to reduce a size of the exterior component or to improve a workability of a work of attaching the exterior component to the bus bars.

(ii)

The conductor (1) according to the above (i), in which
the exterior component (4) includes a first block (20) that constitutes one of the pair of groove portions (21) and a second block (30) that constitutes the other of the pair of groove portions (31) and is separate from the first block (20),
one of the pair of cover portions (23) is coupled to the first block (20) so as to be displaceable in a hinge shape, and is engaged with an engaged portion (25) provided in the first block (20) when the opening portion of the one of the groove portions (21) is closed, and
the other of the pair of cover portions (33, 36) is coupled to the second block (30) so as to be displaceable in a hinge shape, is engaged with an engaged portion (35) provided in the second block (30) when the opening portion of the other of the groove portions (31) is closed, overlaps the one of the cover portions (23), and couples the first block (20) and the second block (30).

According to the conductor having the configuration of the above (ii), the one of the cover portions is coupled to the first block of the exterior component so as to be displaceable in a hinge shape. Further, when the opening portion of the groove portion in the first block is closed by the cover portion (one of the cover portions), the cover portion is engaged with the engaged portion provided in the first block. In contrast, the other of the cover portions is coupled to the second block of the exterior component so as to be displaceable in a hinge shape. Further, when the opening portion of the groove portion in the second block is closed by the cover portion (the other of the cover portions), the cover portion is engaged with the engaged portion provided in the second block, overlaps the cover portion (the one of the cover portions) that closes the opening portion of the groove portion in the first block, and couples the first block and the second block. Accordingly, even though the first block and the second block are separate bodies, the first block and the second block can be coupled to each other by any one of the pair of cover portions while the order of opening the pair of cover portions is restricted.

The first block and the second block do not have to be separate bodies, and may be an integral member coupled to each other.

What is claimed is:

1. A conductor comprising:
a pair of bus bars; and
an exterior component attached to the pair of bus bars, wherein
each of the pair of bus bars includes a conductor portion and an insulating sheath with which the conductor portion is covered, and at least partially includes an attached portion extending in a linear shape,
the exterior component includes a pair of groove portions extending in a linear shape so as to be capable of accommodating the attached portions of the pair of bus bars, and a pair of cover portions capable of opening and closing opening portions of the pair of groove portions, and
the pair of cover portions are arranged such that one and the other of the pair of cover portions overlap each other when the opening portions of both of the pair of groove portions are closed.

2. The conductor according to claim 1, wherein
the exterior component includes a first block that constitutes one of the pair of groove portions and a second block that constitutes the other of the pair of groove portions and is separate from the first block,
one of the pair of cover portions is coupled to the first block so as to be displaceable in a hinge shape, and is engaged with an engaged portion provided in the first block when the opening portion of the one of the groove portions is closed, and
the other of the pair of cover portions is coupled to the second block so as to be displaceable in a hinge shape, is engaged with an engaged portion provided in the second block when the opening portion of the other of the groove portions is closed, overlaps the one of the cover portions, and couples the first block and the second block.
